(19) United States
(12) Patent Application Publication
(10) Pub. No.: US 2024/0367176 A1
(43) Pub. Date: Nov. 7, 2024

(54) METHOD FOR SQUEEZING SOYBEANS, CEREALS OR NUTS/SEEDS AND SQUEEZING DEVICE

(71) Applicant: TAKAI TOFU & SOYMILK EQUIPMENT CO., Ishikawa (JP)

(72) Inventors: Toichiro TAKAI, Ishikawa (JP); Toru AWAZU, Ishikawa (JP); Motonari AMANO, Ishikawa (JP); Makoto JIOU, Ishikawa (JP); Yusuke SETO, Ishikawa (JP); Toshiki MATSUMOTO, Ishikawa (JP); Katsuya TOKINAGA, Ishikawa (JP); Riku YOSHIDA, Ishikawa (JP)

(73) Assignee: TAKAI TOFU & SOYMILK EQUIPMENT CO., Ishikawa (JP)

(21) Appl. No.: 18/556,654

(22) PCT Filed: Aug. 26, 2022
(86) PCT No.: PCT/JP2022/032229

§ 371 Date: Oct. 20, 2023

(30) Foreign Application Priority Data
Aug. 27, 2021 (JP) 2021-139260

(51) Int. Cl. B02C 23/08; B02C 23/18

(52) U.S. Cl. CPC B02C 23/08; B02C 23/18

(57) ABSTRACT

A squeezing device includes: a crushing device that crushes primary soybean slurry obtained by mixing pulverized soybeans and warm water together with warm water to obtain secondary soybean slurry in a heated state; a deaeration device that deaerates the secondary slurry having a temperature of 40° C. or higher, which is conveyed without heating from the crushing device; a heating device that heats deaerated secondary slurry to obtain heated slurry; and a solid-liquid separation device that solid-liquid separates the heated slurry.

### TECHNICAL FIELD

The present invention relates to a method for squeezing soybeans, cereals, or nuts and seeds, and a squeezing device used for squeezing soybeans, cereals, or nuts and seeds and producing beverages and other products.

### BACKGROUND ART

In general, when producing soy milk, a method is adopted in which soybean slurry (also called raw soybean paste) obtained by crushing soybeans is added into a heating pot, the soybean slurry is boiled by heating to extract water-soluble proteins in the soybean slurry and promote heat denaturation of proteins, and then solid-liquid separation is performed.

In the process of crushing the soybeans and the process of transferring the soybean slurry obtained by crushing, the soybean slurry tends to contain air bubbles, and when the soybean slurry containing the air bubbles is heated in the pot, many bubbles expand, rise to the surface, and spill over. Therefore, it is necessary to reduce the amount of soybean slurry to be prepared to about half or less of a volume of the pot, and there is a problem that the volume of the pot for boiling the soybean slurry cannot be used effectively.

In addition, a lot of air bubbles contained in the soybean slurry hinder heat transfer to the soybeans, making it difficult to uniformly heat the soybeans, which may affect the quality of the soy milk to be obtained.

In addition, when transferring the soybean slurry containing a lot of air bubbles to the device of the next process, the bubbles may flow ahead or cavitation may occur, making it impossible to transfer the liquid, which also causes the problem that the pump that transfers the soybean slurry does not function normally.

Therefore, in the related art, when using a batch pot as the heating pot, in order to suppress the generation of bubbles, a method for adding an antifoaming agent (powder or liquid) before sending the soybean slurry into the pot, or a method for adding the antifoaming agent into the pot is generally adopted.

However, in recent years, consumers are being more health conscious, and are committed to using only soybeans, water, and coagulants, there is an increasing demand for tofu products (including a tofu product, which is an organic agricultural processed food) that do not use food additives such as antifoaming agents.

Therefore. Patent Literature 1 proposes a soy milk production device including a boiling can of airtight structure, a decompression means for reducing an air pressure in the boiling can, and a soybean juice supply means for supplying soybean juice into the decompressed boiling can. According to Patent Literature 1, it is described that the soybean juice can be boiled and the air bubbles can be removed without using the antifoaming agent.

### CITATION LIST

### Patent Literature

Patent Literature 1: JP2002-306104A

### SUMMARY OF INVENTION

### Technical Problem

However, when secondary soybean slurry is heated in a closed path, such as a continuous heating pot, it is difficult to separate the bubbles because the antifoaming agent cannot be used during heating.

In addition, when using the soy milk production device described in Patent Literature 1, a means for heating the inside of the boiling can or a means for boiling the soybean juice immediately before the boiling can is required, which increases the number of production processes, heating conditions may vary due to burning of the heated portion or a closed environment, and cleaning costs may be added, resulting in an increase in the overall manufacturing cost. Furthermore, with the method described in Patent Literature 1, it is difficult to deaerate the gas dissolved in the soybean juice.

The present invention has been made in view of the above problems, and an object thereof is to provide a method for squeezing soybeans, cereals, or nuts and seeds and a squeezing device, which can be applied to the squeezing of cereals or nuts and seeds in addition to soybeans, in which the generation and expansion of bubbles (spilling over) in a heating process of boiling soybeans, cereals, or nuts and seeds can be suppressed without using a special boiling means or the antifoaming agent for deaerating secondary slurry, and dissolved gas in the secondary slurry can be easily deaerated.

### Solution to Problem

According to an aspect of the present invention, there is provided a method for squeezing soybeans, cereals, or nuts and seeds, including: an immersion process of immersing soybeans, cereals, or nuts and seeds in warm water of 40° C. or higher for a predetermined period of time to obtain primary slurry; a crushing process of crushing the primary slurry with warm water to obtain secondary slurry in a heated state; a deaeration process of deaerating the secondary slurry having a temperature of 40° C. or higher, which is conveyed after the crushing process; a heating process of heating the deaerated secondary slurry to obtain heated slurry; and a solid-liquid separation process of solid-liquid separating the heated slurry.

In the method for squeezing soybeans, cereals, or nuts and seeds according to the aspect of the present invention, an enzyme deactivation process of heating the soybeans or the primary slurry to a temperature of 70° C. or higher before the crushing process or simultaneously with the crushing process to deactivate enzymes with heat may further be provided.

In the method for squeezing soybeans, cereals, or nuts and seeds according to the aspect of the present invention, the soybeans can be, for example, at least one selected from whole soybeans, pulverized soybeans obtained by coarsely pulverizing raw soybeans, ground soybeans obtained by grinding raw soybeans by a dry method, dehulled hypocotyl-removed ground soybean obtained by removing hypocotyls and seed coats of the ground soybeans, and flaked soybeans.

In the method for squeezing soybeans, cereals, or nuts and seeds according to the aspect of the present invention, a heating process of heating the secondary slurry such that a raised temperature is 20° C. or lower, or a heat retaining process of retaining a temperature of the secondary slurry may further be provided between the crushing process and the deaeration process.

In the method for squeezing soybeans, cereals, or nuts and seeds according to the aspect of the present invention, it is preferable that the secondary slurry is conveyed to the deaeration process without being heated from the crushing process.

According to another aspect of the present invention, there is provided a squeezing device for squeezing soybeans, cereals, or nuts and seeds, including: an immersion device that immerses soybeans, cereals, or nuts and seeds in warm water of 40° C. or higher for a predetermined period of time to obtain primary slurry; a crushing device that crushes the primary slurry with warm water to obtain secondary slurry in a heated state; a deaeration device that deaerates the secondary slurry having a temperature of 40° C. or higher, which is conveyed from the crushing device; a heating device that heats the deaerated secondary slurry to obtain heated slurry; and a solid-liquid separation device that solid-liquid separates the heated slurry.

In the squeezing device for squeezing soybeans, cereals, or nuts and seeds according to the aspect of the present invention, an enzyme deactivation device that heats the soybeans or the primary slurry to a temperature of 70° C. or higher to deactivate enzymes with heat may further be provided.

In the squeezing device for squeezing soybeans, cereals, or nuts and seeds according to the aspect of the present invention, the immersion device may be an enzyme deactivation and immersion device that performs an enzyme deactivation process of heating the soybeans to a temperature of 70° C. or higher for deactivating enzymes with heat.

In the squeezing device for squeezing soybeans, cereals, or nuts and seeds according to the aspect of the present invention, the crushing device can be an enzyme deactivation and crushing device that performs an enzyme deactivation process of heating the primary slurry to a temperature of 70° C. or higher for deactivating enzymes with heat.

In the squeezing device for squeezing soybeans, cereals, or nuts and seeds according to the aspect of the present invention, it is preferable that a heating device that heats the secondary slurry within a range of 20° C. or lower, or a heat retaining device that retains a temperature of the secondary slurry further be provided between the crushing device and the deaeration device.

In the squeezing device for squeezing soybeans, cereals, or nuts and seeds according to the aspect of the present invention, it is preferable that the secondary slurry is conveyed from the crushing device to the deaeration device without being heated.

In the squeezing device for squeezing soybeans, cereals, or nuts and seeds according to the aspect of the present invention, the soybeans can be, for example, at least one selected from whole soybeans, pulverized soybeans obtained by coarsely pulverizing raw soybeans, ground soybeans obtained by grinding raw soybeans by a dry method, dehulled hypocotyl-removed ground soybean obtained by removing hypocotyls and seed coats of the ground soybeans, and flaked soybeans.

In the squeezing device for squeezing soybeans, cereals, or nuts and seeds according to the aspect of the present invention, for example, a slurry tank that temporarily stores and stirs the secondary slurry may further be provided between the crushing device and the deaeration device.

In the squeezing device for squeezing soybeans, cereals, or nuts and seeds according to the aspect of the present invention, for example, a conveyance device that supplies the secondary slurry to the deaeration device at a temperature of 40° C. or higher may further be provided between the crushing device and the deaeration device.

In the squeezing device for squeezing soybeans, cereals, or nuts and seeds according to the aspect of the present invention, it is preferable that the conveyance device is a positive displacement metering pump.

In the squeezing device for squeezing soybeans, cereals, or nuts and seeds according to the aspect of the present invention, it is preferable that the heating device is a continuous heating device that gradually heats the secondary slurry in a closed atmosphere.

In the squeezing device for squeezing soybeans, cereals, or nuts and seeds according to the aspect of the present invention, it is preferable that the crushing device is a stainless steel crushing device.

### Advantageous Effects of Invention

A method for squeezing soybeans, cereals, or nuts and seeds and a squeezing device according to the present invention obtains primary slurry by immersing soybeans (whole soybeans, pulverized soybeans, ground soybeans, flaked soybeans, and the like), cereals, or nuts and seeds in warm water of 40° C. or higher for a predetermined period of time, and obtain secondary slurry in a heated state by crushing the primary slurry. The secondary slurry contains a lot of air, but according to the present invention, even dissolved gas can be easily deaerated without using a special boiling means or an antifoaming agent, and generation and expansion of bubbles in a heating process can be suppressed to perform boiling (cooking) uniformly and evenly. Therefore, the present invention is useful for the production of differentiated products such as products produced by the production method without using the antifoaming agent and organic agricultural processed foods. In addition, according to the present invention, squeezing can be performed with the minimum necessary amount of antifoaming agent, and thus cost reduction effect can be expected amid soaring raw material costs.

### BRIEF DESCRIPTION OF DRAWINGS

FIG. 1 is a schematic view showing a configuration of a soy milk production device according to a first embodiment of the present invention.

FIG. 2 is a schematic view showing a configuration of a soy milk production device according to a second embodiment of the present invention.

### DESCRIPTION OF EMBODIMENTS

The inventors of the present invention have conducted extensive studies on a method that can efficiently remove air bubbles entrained in secondary slurry of soybeans, cereals, or nuts and seeds during crushing without using a special temperature raising means or an antifoaming agent. As a result, the inventors have found that it is efficient to perform a deaeration process for removing air bubbles prior to the process of heating the secondary slurry to obtain heated slurry. However, in the water ring vacuum pump used for the general specification range of a vacuum generation device, which is selected based on the relationship between water temperature and vapor pressure, for example, for the food industry, when a temperature of the supplied sealing water is 15 to 20° C., it is difficult to obtain an efficient deaeration effect at a degree of vacuum equivalent to the saturated vapor pressure of water at the sealing water temperature. Therefore, in order to efficiently deaerate air bubbles (including dissolved gas) in the secondary slurry by a deaeration device, the secondary slurry is required to be at a temperature of 40° C. or higher.

Therefore, in the present invention, for example, a process of heating soybeans to deactivate enzymes or a process of immersing soybeans, cereals, or nuts and seeds in warm water for swelling of soybeans, cereals, or nuts and seeds regardless of whether the enzymes are deactivated or not, is performed before the deaeration process. After that, by using the secondary slurry reaching a predetermined temperature (at least 40° C.) or higher, it is possible to efficiently deaerate without heating for deaeration.

In the present invention, the production method without using the antifoaming agent is preferable, but the production method using the minimum necessary amount of antifoaming agent is also applicable. Accordingly, the amount of antifoaming agent to be added can be reduced compared to the related art, and the economic effect can be expected. In particular, it is possible to use the minimum necessary amount of liquid antifoaming agent that can provide an antifoaming effect even when the water temperature is 60° C. or lower, and for example, effects can be obtained by using an extremely small amount of 0.1 to 3.0 g per kg of raw soybeans. In that case, even with a thick secondary soybean slurry (soybean juice) with a soy milk concentration of 12 to 20% Brix (water 2.0 to 5 kg per kg of raw soybeans, water addition ratio 2.0 to 5 times), it is possible to perform an operation synergistically with the deaeration effect caused by the deaeration device and improve the deaeration effect.

In addition, preferably, the immersing temperature of soybeans, cereals, or nuts and seeds is adjusted such that the secondary slurry reaches 40° C. or higher in the deaeration process, and the secondary slurry is conveyed to the deaeration process without heating from the crushing process. However, during the conveyance of the secondary slurry, a heat retaining process of retaining the temperature of the secondary slurry, or a heating process of heating the secondary slurry such that the temperature is maintained or a raised temperature is 20° C. or lower, may be performed.

Hereinafter, embodiments of the present invention will be described in detail with reference to the drawings. It is to be noted that the present invention is not limited to the embodiments described below, and can be randomly modified without departing from the gist of the present invention.

### Method for Squeezing Soybeans, Cereals, or Nuts/Seeds

### First Embodiment

Hereinafter, as a first embodiment of a method for squeezing soybeans, cereals, or nuts and seeds and a squeezing device according to the present invention, a method for squeezing soybeans (tofu production method) and a squeezing device (soy milk production device) will be described in detail with reference to the drawings.

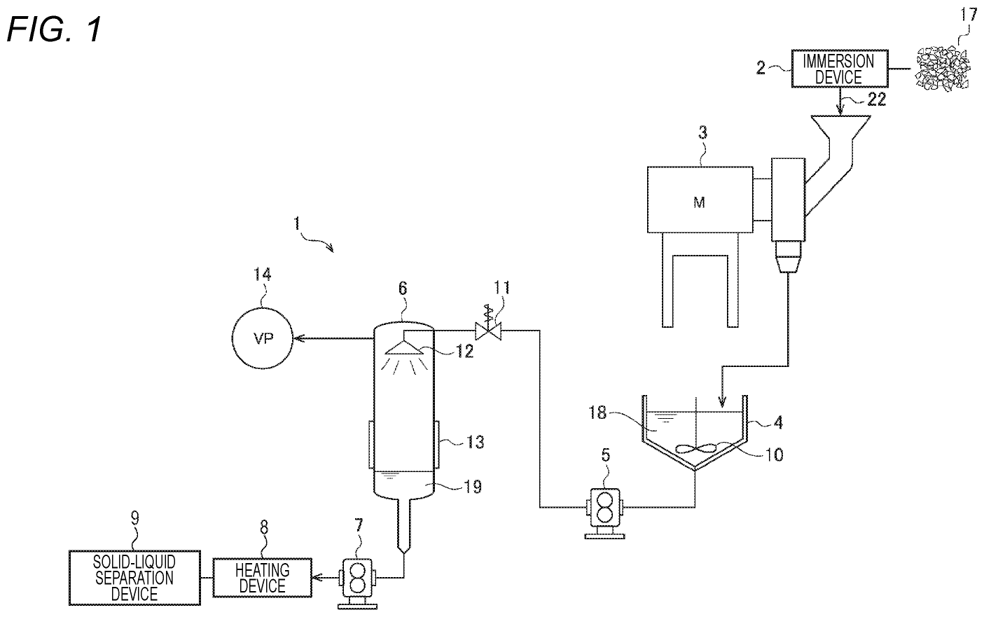

FIG. 1 is a schematic view showing a configuration of the soy milk production device according to the first embodiment of the present invention.

As shown in FIG. 1, the soy milk production device according to the first embodiment includes: an immersion device 2 that immerses ground soybeans 17 at a predetermined temperature for a predetermined period of time to obtain primary soybean slurry (primary slurry) 22; a crushing device 3 that crushes the primary soybean slurry 22 with warm water to obtain secondary soybean slurry (secondary slurry) 18 in a heated state; a slurry tank 4 that temporarily stores and stirs the obtained secondary soybean slurry 18; a first pump (conveyance device) 5 that conveys the secondary soybean slurry 18 in the slurry tank 4 to a deaeration device 6 of the next process; the deaeration device 6 that deaerates the secondary soybean slurry 18; a second pump 7 that conveys a deaerated secondary soybean slurry 19; a heating device 8 that heats the deaerated secondary soybean slurry 19 to obtain boiled paste; and a solid-liquid separation device (squeezing machine) 9 that solid-liquid separates the obtained boiled paste into bean curd refuse and soy milk.

When producing soy milk using the soy milk production device 1 configured as described above, first, in the immersion device 2, the ground soybeans 17 are mixed with warm water heated to a predetermined temperature (for example, 40° C.) or higher, and immersed, for example, for 1 second to 3 hours, preferably 1 minute to 1 hour, to obtain the primary soybean slurry 22 (immersion process). Next, the swollen primary soybean slurry 22 is supplied to the crushing device 3 and ground together with warm water to obtain the secondary soybean slurry 18 (so-called raw soybean paste) (crushing process). As the crushing device 3, a general crushing device such as a stainless steel screen mill type (hammer mill type) or a stainless steel or sintered abrasive grain stone mill type can be used. However, it is preferable to use a stainless steel crushing device that does not chip off the abrasive grains because there is a concern that the abrasive grains chip off and become foreign matter, or that the abrasive grains damage the machine and shorten the life expectancy thereof. In addition, the crushing device may be of a submerged crushing type in which less air is mixed during crushing, but the present invention may be the above-described general crushing method in which a large amount of air is mixed during crushing. Since the secondary soybean slurry (raw soybean paste) contains air, a specific gravity is preferably 1.00 or less, and preferably 0.50 or more. When the specific gravity is more than 1.00, deaeration is not necessary, and when the specific gravity is less than 0.50, liquid feeding of the pump is hindered.

After that, in a state where the secondary soybean slurry 18 is temporarily stored in the slurry tank 4 and stirred by a stirrer 10, and the warm water and the soybeans are uniformly mixed, the secondary soybean slurry 18 is conveyed to the deaeration device 6 through a flow rate adjustment valve 11 by a first pump 5. In the first embodiment, a rotary pump is used as the first pump 5, but the type of pump is not particularly limited as long as the pump is a positive displacement pump capable of feeding solid-liquid. For example, generally used positive displacement metering pumps such as gear pumps, diaphragm pumps, plunger pumps, and rotary positive displacement single shaft eccentric screw pumps (Mohno Pump (registered trademark)) can be used.

A vacuum pump 14 is connected to the deaeration device 6, and an inside of the deaeration device 6 can be decompressed by the vacuum pump 14. The timing of decompression is not particularly limited, and in a state where the inside of the deaeration device 6 is adjusted to a predetermined pressure by the vacuum pump 14 in advance and decompressed to be equal to or lower than the atmospheric pressure, it is preferable to supply the secondary soybean slurry 18 at a temperature of 40° C. or higher into the deaeration device 6 from a nozzle 12. Although not shown, a vacuum control valve for adjusting the pressure in a can body of the deaeration device may be provided.

When the heating device 8 that heats the deaerated secondary soybean slurry 19 is of a continuous type, in a state where the inside of the deaeration device 6 is decompressed in advance, it is preferable to supply the secondary soybean slurry 18 from the nozzle 12 into the deaeration device 6.

When the secondary soybean slurry 18 is continuously supplied into the deaeration device 6 in a state where the inside of the deaeration device 6 is decompressed, the secondary soybean slurry 18 supplied into the deaeration device 6 is sprayed toward an inner wall of the deaeration device 6 by the nozzle 12. The secondary soybean slurry 18 boils at the same time as the supply into the decompressed deaeration device 6, and accordingly, the air contained in the secondary soybean slurry 18 is removed, the secondary soybean slurry 18 collides with the inner wall of the deaeration device, and then flows down along the inner wall. When the secondary soybean slurry 18 collides with the inner wall, new bubbles are generated by the impact of the collision. However, a cooling jacket 13 is provided on an outer circumferential surface of the deaeration device 6, the gas that forms the bubbles is vapor, and thus, a can wall is cooled when the secondary soybean slurry 18 flows down on the inner side of the cooling jacket 13, and the vapor bubbles generated at the time of collision condense and disappear (deaeration process).

From the saturated vapor pressure at the inflow temperature of the secondary soybean slurry (for example, refer to the “Steam Table” of the Japan Society of Mechanical Engineers. 40° C.; 7.375 kPa, 50° C.; 12.335 kPa, 60° C.; 19.92 kPa, 70° C.; 31.162 kPa, 80° C.; 47.36 kPa, 90° C.; 70.10) kPa, 100° C.; 101.325 kPa), when water instantly boils and the temperature of the secondary soybean slurry decreases to the temperature at the pressure inside the pipe of the deaeration device, the dissolved air is also removed at the same time.

As described above, since the cooling jacket 13 is provided on the outer circumferential surface of the deaeration device 6, the bubbles with a large amount of vapor that remain after foaming and floating are cooled and condensed or contracted (deaeration process). In the specification of the present application, a continuous type deaeration device is described as a preferred form of the deaeration device.

After that, the secondary soybean slurry in the can body is continuously taken out by the second pump 7 while the inside of the deaeration device 6 is decompressed, and the deaerated secondary soybean slurry 19 is conveyed to the heating device 8. In the heating device 8, the secondary soybean slurry 19 is heated gradually with steam or the like, but at this time, there is no generation or expansion of air bubbles in the secondary soybean slurry 19, and thus heating is performed evenly and uniformly to extract water-soluble proteins and thermally denature proteins homogeneously, and slurry-like boiled paste (heated slurry) is obtained (heating process). The supply and withdrawal of the secondary soybean slurry to and from the deaeration device 6 may be performed in a batch operation, but a continuous operation is preferable because a stable decompression operation can be achieved.

Thereafter, the boiled paste is solid-liquid separated by the solid-liquid separation device 9 to obtain bean curd refuse and soy milk (solid-liquid separation process).

In addition, the type of the second pump 7 that conveys the secondary soybean slurry 19 to the heating device 8 is not particularly limited, and the same pump as the first pump 5 can be used.

In the present embodiment, by performing the immersion process of immersing soybeans (whole soybeans, pulverized soybeans, ground soybeans, flaked soybeans, and the like) mixed with warm water, and the crushing process of crushing the primary soybean slurry 22 obtained by the immersion process together with water, warm water, or hot water, an already heated secondary soybean slurry 18 can be obtained. Then, without heating from the crushing process, the secondary soybean slurry 18 can be conveyed to the inside of the can body of which the internal pressure is set to the minimum pressure of 7.375 kPa (vapor pressure of 40° C.) of the deaeration device 6 in a state of 40° C. or higher, preferably to the vapor pressure value at a temperature that is 2 to 3° C. lower than the temperature of the conveyed secondary soybean slurry. The conveyed secondary soybean slurry passes through the flow rate adjustment valve 11, and falls down along the inner wall of the pipe via the nozzle 12, during which water rapidly evaporates. With this, the heat of vaporization is removed, the temperature of the secondary soybean slurry is lowered, and at the same time, minute air bubbles and dissolved gases are also removed. As a result, air bubbles contained in the secondary soybean slurry 18 can be easily and efficiently removed.

Thus, according to the present embodiment, it is not necessary to use the antifoaming agent in the heating process for obtaining boiled paste, and the generation of bubbles in the heating process can be easily suppressed. In the present embodiment, the heating device used in the heating process is not particularly limited, and for example, a continuous heating device that gradually heats the deaerated secondary soybean slurry 19 can be used in a closed atmosphere. Since it is generally difficult to use an antifoaming agent in such a continuous heating device, the continuous heating device can be suitably used when using a soy milk production method according to the present embodiment. In addition, it is also possible to inject the liquid antifoaming agent or the like with the positive displacement metering pump, and in the present embodiment, it is possible to suppress the amount of antifoaming agent added to the minimum necessary amount that can provide a quality improvement effect that compensates for fluctuations in raw material quality.

In order to discharge air bubbles contained in the secondary soybean slurry 18 by the deaeration device 6, the temperature of the secondary soybean slurry 18 when the secondary soybean slurry 18 is conveyed to the deaeration device 6 is set to 40° C. or higher, but the enzyme deactivation effect can be obtained by setting the temperature of the secondary soybean slurry 18 to 70° C. or higher, and thus, this is preferable when obtaining soy milk with less unpleasant taste such as soy milk beverages. Also, the upper limit of the temperature of the secondary soybean slurry 18 when the secondary soybean slurry 18 is conveyed to the deaeration device 6 is not particularly limited, and for example, it is preferable to set the temperature to 100° C. or lower, and from the viewpoint of safe operation, it is more preferable to set the temperature to 90° C. or lower.

In the present invention, a known method can be used to obtain the secondary soybean slurry 18 in a heated state. For example, as shown in the first embodiment, in addition to a method for immersing the ground soybeans 17 in warm water, a method for immersing whole soybeans in warm water, or a method for deactivating enzymes shown as a second embodiment below may be used.

In the present invention, the soybeans to be used are not particularly limited. At least one selected from whole soybeans, pulverized soybeans obtained by coarsely pulverizing raw soybeans, the ground soybeans 17 obtained by grinding raw soybeans by a dry method, dehulled hypocotyl-removed ground soybeans obtained by removing hypocotyls and seed coats of the ground soybeans 17, and flaked soybeans, can be used. The flaked soybeans can be obtained, for example, by a means for pressing into flakes by a dry method.

Furthermore, the soy milk obtained by the production method according to the present invention may be used as a beverage, or may be used for tofu or secondary products using soy milk, such as deep-fried tofu and silken tofu cutlet.

The production of soy milk beverages may include a process of heating soybeans or the like to deactivate enzymes. Therefore, the secondary soybean slurry in a heated state can also be obtained by using heating to deactivate enzymes.

### Second Embodiment

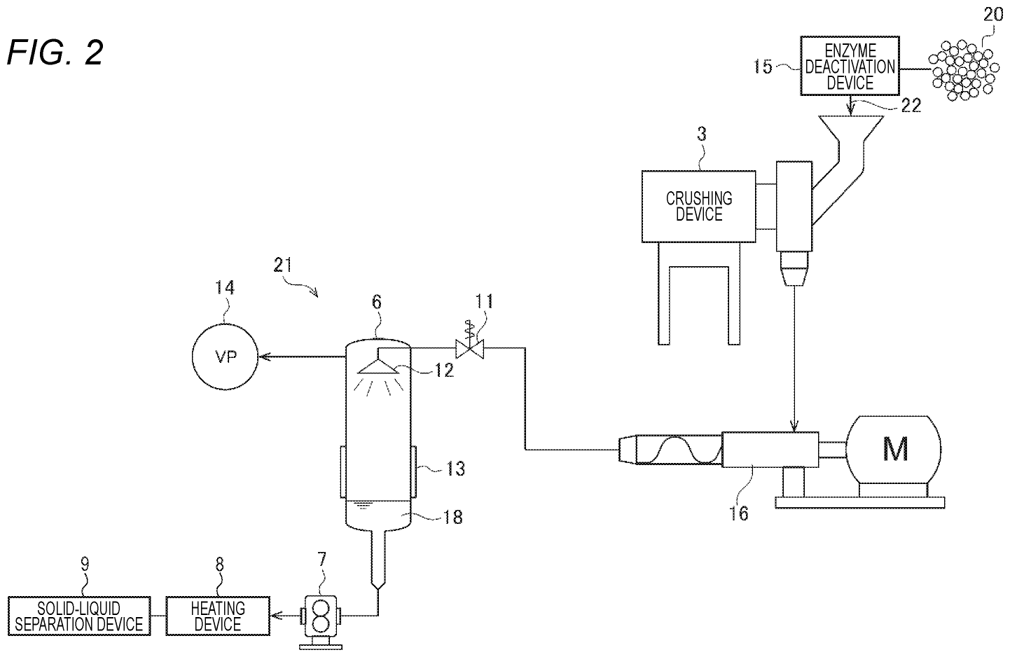

Hereinafter, as the second embodiment of the present invention, a method for squeezing soybeans (soy milk production method) and a squeezing device (soy milk production device) will be described in detail with reference to the drawings. FIG. 2 is a schematic view showing a configuration of the soy milk production device according to the second embodiment of the present invention. The soy milk production device and the soy milk production method according to the second embodiment will be described with reference to FIG. 2. In FIG. 2, the same or equivalent parts as those of the first embodiment will be given the same reference numerals in the drawing, and the description thereof will be omitted or simplified.

A soy milk production device (squeezing device) 21 according to the second embodiment includes an enzyme deactivation device (enzyme deactivation and immersion device) 15 that heats soybeans 20 with a heating medium such as vapor, hot water, hot air, or superheated vapor, at a predetermined temperature for a predetermined period of time, before the crushing device 3. At this time, rather than dry heat, wet heat with water spraying is preferable in terms of efficiency and yield because the device also serves as an immersion device at the same time when enzymes are deactivated. Further, in the first embodiment, the slurry tank 4 that temporarily stores the secondary soybean slurry 18, and the first pump 5 that conveys the secondary soybean slurry 18 in the slurry tank 4 to the deaeration device are provided between the crushing device 3 and the deaeration device 6, but in the second embodiment, instead of the slurry tank 4 and the first pump 5, a rotary positive displacement single shaft eccentric screw pump (Mohno Pump (registered trademark)) 16 is provided.

As in the first embodiment, the pump to be used is not limited to the rotary positive displacement single shaft eccentric screw pump, and positive displacement metering pumps such as rotary pumps, gear pumps, diaphragm pumps, and plunger pumps can be used.

As a method for producing soy milk using the soy milk production device 21 configured as described above, the soybeans 20 are first supplied into an enzyme deactivation device 15. In addition, the primary soybean slurry obtained by immersing the soybeans 20 in warm water may be supplied into the enzyme deactivation device 15. The enzyme deactivation device 15 is configured to heat the water and the soybeans 20 (or the primary soybean slurry 22) with steam or the like, and the supplied water and soybeans 20 (or the primary soybean slurry 22) are heated under predetermined conditions (for example, 70 to 100° C. for 1 second to 600 seconds)(enzyme deactivation process). It is to be noted that, by the enzyme deactivation process at 80° C. or higher, it is also possible to sterilize germs adhering to the soybeans 20 (or the primary soybean slurry 22). Also, the immersion process may be sequentially performed after the enzyme deactivation process.

The soybeans 20 (or the primary soybean slurry 22) in which the enzymes endogenous to soybeans are deactivated with heat by the enzyme deactivation device 15 are crushed by the crushing device 3, and as in the first embodiment, the secondary soybean slurry 18 in which warm water and finely crushed soybeans are mixed is obtained (crushing process).

The obtained secondary soybean slurry 18 is conveyed by the rotary positive displacement single shaft eccentric screw pump 16. The rotary positive displacement single shaft eccentric screw pump 16 has the function of conveying the secondary soybean slurry 18 while uniformly mixing the warm water and the raw soybean paste, and the secondary soybean slurry 18 is conveyed from the crushing device 3 to the deaeration device 6 in a closed and non-open environment. The deaeration process in the deaeration device 6 and subsequent processes are the same as those in the first embodiment.

In the second embodiment, the soybeans (or primary soybean slurry) heated to 70° C. or higher by the enzyme deactivation device 15 are crushed together with water, warm water, and the like to form the secondary soybean slurry 18. Without heating the secondary soybean slurry 18, the secondary soybean slurry 18 is conveyed to the deaeration device 6 at a temperature of at least 40° C. or higher and 100° C. or lower, and thus, without using the antifoaming agent or the heating device for deaeration, air bubbles in the secondary soybean slurry 18 can be discharged relatively easily.

In addition, in the first and second embodiments, the secondary soybean slurry 18 is conveyed to the deaeration device 6 without being heated. However, the heat retaining device may be disposed between the crushing device 3 and the deaeration device 6 to maintain the temperature of the secondary soybean slurry 18 during the conveyance of the secondary soybean slurry 18. Furthermore, the heating device may be disposed between the crushing device 3 and the deaeration device 6 to heat the secondary slurry such that a raised temperature is 20° C. or lower.

In addition, in the second embodiment, the enzyme deactivation device 15 is disposed before the crushing device 3, but the position where the enzyme deactivation device 15 is installed is not limited to this. For example, a method may be adopted in which the crushing device (enzyme deactivation and crushing device) 3 that also serves as the enzyme deactivation device 15 that heats the primary soybean slurry after immersion to a temperature of 70° C. or higher is used to crush and heat the slurry. Even in this case, the secondary soybean slurry 18 is conveyed to the deaeration device 6 at 70 to 100° C. without being heated from the enzyme deactivation device, and thus the air bubbles in the secondary soybean slurry 18 can be more easily discharged.

In the second embodiment, instead of the slurry tank 4 and the first pump 5 described in the first embodiment, the rotary positive displacement single shaft eccentric screw pump 16 is provided. Thereby, as described above, the secondary soybean slurry 18 can be conveyed from the crushing device 3 to the deaeration device 6 in a closed environment, and thus hygiene can be improved compared to the first embodiment. In addition, since the slurry tank 4 is an open type, it is necessary to monitor such that the secondary soybean slurry 18 does not overflow from the slurry tank 4.

On the other hand, the rotary positive displacement single shaft eccentric screw pump 16 is set to have a volume to be conveyed larger than the amount supplied from the crushing device 3, and can convey the secondary soybean slurry 18 to the deaeration device 6 while sucking the outside air. In this manner, when the secondary soybean slurry 18 is conveyed while sucking the outside air, the secondary soybean slurry 18 contains a lot of air bubbles. However, in the present embodiment, before the secondary soybean slurry 18 is conveyed to the heating device 8, air bubbles are discharged by the deaeration device 6, and thus the rotary positive displacement single shaft eccentric screw pump 16 can be preferably used. In addition, by setting the volume to be conveyed to be larger than the amount supplied to the rotary positive displacement single shaft eccentric screw pump 16, clogging of the pump can be prevented and monitoring becomes unnecessary. Therefore, in the present invention, the type of pump may be selected as necessary.

In addition, the soy milk production methods and the soy milk production devices according to the first and second embodiments are methods and devices for producing soy milk by processing soybeans. However, the present invention can also be applied to plant-based milk production using cereals other than soybeans (beans such as adzuki beans, peas, green peas, broad beans, and green soybeans), nuts and seeds (nuts and seeds having a large amount of oils and proteins such as nuts (peanuts, almonds, cashews, hazelnuts, macadamia nuts, pistachios, pecans, walnuts, and coconuts), hemp seeds, pumpkins, sunflowers, pine nuts, and sesame seeds, millets such as pearl millet, finger millet, proso millet, foxtail millet, and barnyard millet, and pseudo-grains such as quinoa, chia seeds, and amaranth) as a raw material, by replacing the soy milk production method and the production device with the “method for squeezing soybeans, cereals, or nuts and seeds and squeezing device”. As in the case of soybeans, with these raw materials, it is possible to produce plant-based milk such as soy milk by appropriately using pretreatment processes such as coarse pulverizing, grinding, or enzymes deactivation heating, immersion process, water adding process, crushing process, deaeration process, separation process, and heating process. Raw materials, such as peanuts, hemp seeds, and sunflowers tend to have a grassy flavor, which is not preferable. Therefore, in this case, flavor improvement can be expected by roasting the raw materials in advance or performing enzyme deactivation treatment or deaeration treatment by heating (70 to 100° C.) such as dry heat or wet heat.

In addition, beans with a high starch content such as adzuki beans, peas, green peas, broad beans, green soybeans, and immature soybeans can be used by replacing the immersion device and the enzyme deactivation device of the present application with an enzymatic reaction saccharification device. In this case, in the enzymatic reaction saccharification device, by activating an endogenous saccharifying enzyme such as O-amylase at a temperature of 50 to 80° C., preferably 55 to 75° C., maltose and the like can be generated to increase sweetness.

Although various embodiments have been described above with reference to the drawings, it is needless to say that the present invention is not limited to such examples. It is obvious that those skilled in the art can conceive various modification examples or correction examples within the scope described in the claims, and it is understood that these also belong to the technical scope of the present invention. Moreover, each component in the above embodiments may be combined randomly without departing from the spirit of the invention.

This application is based on a Japanese patent application filed on Aug. 27, 2021 (Japanese Patent Application No. 2021-139260), the content of which is incorporated into this application by reference.

### REFERENCE SIGNS LIST

1, 21 Soy milk production device
2 Immersion device
3 Crushing device
4 Slurry tank
5 First pump
6 Deaeration device
7 Second pump
8 Heating device
9 Solid-liquid separation device
14 Vacuum pump
15 Enzyme deactivation device
16 Rotary positive displacement single shaft eccentric screw pump
17 Ground soybean
18 Secondary soybean slurry
20 Soybean
22 Primary soybean slurry

1. A method for squeezing soybeans, cereals, or nuts and seeds, comprising:
immersing soybeans, cereals, or nuts and seeds in warm water of 40° C. or higher for a predetermined period of time to obtain primary slurry;
crushing the primary slurry with warm water to obtain secondary slurry in a heated state;
deaerating the secondary slurry having a temperature of 40° C. or higher, which is conveyed after the crushing;
heating the deaerated secondary slurry to obtain heated slurry; and
solid-liquid separating the heated slurry.

2. The method for squeezing soybeans, cereals, or nuts and seeds according to claim 1, further comprising:
heating the soybeans or the primary slurry to a temperature of 70° C. or higher before the crushing or simultaneously with the crushing to deactivate enzymes with heat.

3. The method for squeezing soybeans, cereals, or nuts and seeds according to claim 1, wherein
the soybeans are at least one selected from whole soybeans, pulverized soybeans obtained by coarsely pulverizing raw soybeans, ground soybeans obtained by grinding raw soybeans by a dry method, dehulled hypocotyl-removed ground soybean obtained by removing hypocotyls and seed coats of the ground soybeans, and flaked soybeans.

4. The method for squeezing soybeans, cereals, or nuts and seeds according to claim 1, further comprising:
heating the secondary slurry such that a raised temperature is 20° C. or lower, or retaining a temperature of the secondary slurry between the crushing and the deaerating.

5. The method for squeezing soybeans, cereals, or nuts and seeds according to claim 1, wherein
the secondary slurry is conveyed to the deaerating without being heated from the crushing.

6. A squeezing device for squeezing soybeans, cereals, or nuts and seeds, comprising:
an immersion device that immerses soybeans, cereals, or nuts and seeds in warm water of 40° C. or higher for a predetermined period of time to obtain primary slurry;
a crushing device that crushes the primary slurry with warm water to obtain secondary slurry in a heated state;
a deaeration device that deaerates the secondary slurry having a temperature of 40° C. or higher, which is conveyed from the crushing device;
a heating device that heats the deaerated secondary slurry to obtain heated slurry; and
a solid-liquid separation device that solid-liquid separates the heated slurry.

7. The squeezing device for squeezing soybeans, cereals, or nuts and seeds according to claim 6, further comprising:
an enzyme deactivation device that heats the soybeans or the primary slurry to a temperature of 70° C. or higher to deactivate enzymes with heat.

8. The squeezing device for squeezing soybeans, cereals, or nuts and seeds according to claim 6, wherein
the immersion device is an enzyme deactivation and immersion device that performs an enzyme deactivation process of heating the soybeans to a temperature of 70° C. or higher for deactivating enzymes with heat.

9. The squeezing device for squeezing soybeans, cereals, or nuts and seeds according to claim 6, wherein
the crushing device is an enzyme deactivation and crushing device that performs an enzyme deactivation process of heating the primary slurry to a temperature of 70° C. or higher for deactivating enzymes with heat.

10. The squeezing device for squeezing soybeans, cereals, or nuts and seeds according to claim 6, further comprising:
a heating device that heats the secondary slurry within a range of 20° C. or lower, or a heat retaining device that retains a temperature of the secondary slurry between the crushing device and the deaeration device.

11. The squeezing device for squeezing soybeans, cereals, or nuts and seeds according to claim 6, wherein
the secondary slurry is conveyed from the crushing device to the deaeration device without being heated.

12. The squeezing device for squeezing soybeans, cereals, or nuts and seeds according to claim 6, wherein
the soybeans are at least one selected from whole soybeans, pulverized soybeans obtained by coarsely pulverizing raw soybeans, ground soybeans obtained by grinding raw soybeans by a dry method, dehulled hypocotyl-removed ground soybean obtained by removing hypocotyls and seed coats of the ground soybeans, and flaked soybeans.

13. The squeezing device for squeezing soybeans, cereals, or nuts and seeds according to claim 6, further comprising:
a slurry tank that temporarily stores and stirs the secondary slurry between the crushing device and the deaeration device.

14. The squeezing device for squeezing soybeans, cereals, or nuts and seeds according to claim 6, further comprising:
a conveyance device that supplies the secondary slurry to the deaeration device at a temperature of 40° C. or higher between the crushing device and the deaeration device.

15. The squeezing device for squeezing soybeans, cereals, or nuts and seeds according to claim 14, wherein
the conveyance device is a positive displacement metering pump.

16. The squeezing device for squeezing soybeans, cereals, or nuts and seeds according to claim 6, wherein
the heating device is a continuous heating device that gradually heats the secondary slurry in a closed atmosphere.

17. The squeezing device for squeezing soybeans, cereals, or nuts and seeds according to claim 6, wherein
the crushing device is a stainless steel crushing device.
